(19) United States
(12) Patent Application Publication
(10) Pub. No.: US 2026/0170065 A1
(43) Pub. Date: Jun. 18, 2026

(54) METHOD, APPARATUS, DEVICE AND STORAGE MEDIUM FOR INFORMATION SEARCHING

(71) Applicant: DOUYIN VISION CO., LTD., Shijingshan District, Beijing (CN)

(72) Inventors: Zhidan Liu, Beijing (CN); Zexun Zhang, Beijing (CN)

(21) Appl. No.: 19/124,608

(22) PCT Filed: Jun. 26, 2024
(86) PCT No.: PCT/CN2024/101756

§ 371 Date: Apr. 25, 2025

(51) Int. Cl. G06F 16/951; G06F 16/9535

(52) U.S. Cl. CPC G06F 16/951; G06F 16/9535

(57) ABSTRACT

The embodiment in the disclosure relates to a method, an apparatus, a device and a storage medium for information searching. The proposed method includes: obtaining input information expressed in natural language; processing the input information with a first model to generate an intention description text for the input information; in response to the intention description text indicating a search intention of a target type, determining a set of search parameters based on the intention description text; and obtaining at least one matched search result by using a target search tool based on the set of search parameters, the target search tool matching the search intention of the target type.

### FIELD

Example embodiments in the present disclosure generally relate to the field of computers, and in particular, to a method, an apparatus, a device, and a computer-readable storage medium for information searching.

### BACKGROUND

With the development of mobile Internet and location services technologies, more and more users use search engines to find points of interest (POIs) such as places and stores nearby. Therefore, how to find a point of interest based on the natural language intention of the user becomes a focus problem concerned by people.

### SUMMARY

In a first aspect of the present disclosure, a method for information searching is provided. The method includes: obtaining input information expressed in natural language; processing the input information with a first model to generate an intention description text for the input information; in response to the intention description text indicating a search intention of a target type, determining a set of search parameters based on the intention description text; and obtaining at least one matched search result by using a target search tool based on the set of search parameters, the target search tool matching the search intention of the target type.

In a second aspect of the present disclosure, an apparatus for information searching is provided. The apparatus includes: a request obtaining module configured to obtain input information expressed in natural language; a request processing module configured to process the input information by using a first model to generate an intention description text for the input information; a parameter determination module configured to determine a set of search parameters based on the intention description text in response to the intention description text indicating a search intention of a target type; and a result obtaining module configured to obtain at least one matched search result by using a target search tool based on the set of search parameters, the target search tool matching the search intention of the target type.

In a third aspect of the present disclosure, an electronic device is provided. The device includes at least one processing unit; and at least one memory coupled to the at least one processing unit and storing an instruction for execution by the at least one processing unit, the instruction, when executed by the at least one processing unit, causing the electronic device to perform the method of the first aspect.

In a fourth aspect of the present disclosure, a computer-readable storage medium is provided. The computer-readable storage medium stores a computer program, and the computer program is executable by the processor to implement the method of the first aspect.

In a fifth aspect of the present disclosure, a computer program product is provided. The computer program product includes computer-executable instructions that, when executed by a processor, implement the method according to the first aspect of the present disclosure.

It should be understood that the content described in this content section is not intended to limit the key features or important features of the embodiments in the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments in the present disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments in the present disclosure may be implemented;

FIG. 2 illustrates a flowchart of an example information search process according to some embodiments in the present disclosure;

FIG. 3 illustrates a schematic diagram of an example information search process according to some embodiments in the present disclosure;

FIG. 4 illustrates a schematic structural block diagram of an example information searching apparatus according to some embodiments in the present disclosure; and

FIG. 5 illustrates a block diagram of an electronic device capable of implementing various embodiments in the present disclosure.

### DETAILED DESCRIPTION

Embodiments in the present disclosure will be described in more detail below with reference to the accompanying drawings. While certain embodiments in the present disclosure are shown in the accompanying drawings, it should be understood that the present disclosure may be implemented in various forms, and should not be construed as limited to the embodiments set forth herein. On the contrary, these embodiments are provided for a more thorough and complete understanding of the present disclosure. It should be understood that the drawings and embodiments in the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments in the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments in the present disclosure may relate to data of a user, obtaining and/or use of data, and the like. These aspects all follow the corresponding laws and regulations and related regulations. In the embodiments in the present disclosure, all data is collected, obtained, processed, refined, forwarded, used, etc., all of which are performed on the premise that the user knows and confirms. Accordingly, when implementing the embodiments in the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, if personal information processing is involved, it will only be carried out on the basis of a legal foundation (such as obtaining the consent of the data subject, or when necessary for the performance of a contract, etc.), and will be processed only within the scope specified or agreed upon. Users'refusal to process personal information beyond what is necessary for the basic functionality will not affect their ability to use the basic features.

In the conventional solution, the POI search is mostly based on keyword matching, and the user needs to input precise keywords and screening conditions to obtain satisfactory search results. However, users often use fuzzy natural language to express the search demand in daily life, resulting in a traditional keyword search being unable to effectively understand and meet the user's intention.

The embodiment in the present disclosure provides a solution for information searching. According to the solution, input information expressed in natural language is obtained. The input information with a first model is processed to generate an intention description text for the input information. In response to the intention description text indicating a search intention of a target type, a set of search parameters is determined based on the intention description text. At least one matched search result is determined by using a target search tool based on the set of search parameters, the target search tool matching the search intention of the target type.

In this way, the embodiments in the present disclosure may convert the natural language intention of the user into parameters that may be understood by the search engine, so that the search result better meets the user's real intention and needs, and the user's search experience is improved.

Various example implementations of this scheme are described in detail below in conjunction with the accompanying drawings.

### Example Environment

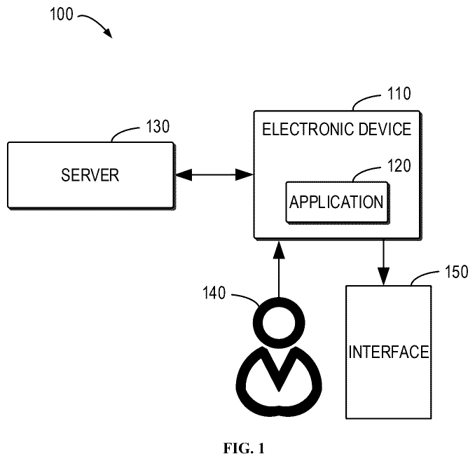

FIG. 1 illustrates a schematic diagram of an example environment 100 in which embodiments in the present disclosure can be implemented. As shown in FIG. 1, the example environment 100 may include an electronic device 110.

In this example environment 100, the electronic device 110 may run an application 120 that supports interface interaction. Application 120 may be any suitable type of application for interface interaction, examples of which may include, but are not limited to, a search-based application, a browser application, an interactive application, or other suitable application. The user 140 may interact with the application 120 via the electronic device 110 and/or its attachment device.

In the environment 100 of FIG. 1, if the application 120 is active, the electronic device 110 may present, via the application 120, an interface 150 for supporting interface interaction.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a independent physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide backend services for applications 120 that support content presentation in the electronic device 110.

A communication connection may be established between the server 130 and the electronic device 110. The communication connection may be established in a wired manner or a wireless manner. Communication connections may include, but are not limited to, Bluetooth connections, mobile network connections, universal serial bus connections, wireless fidelity connections, etc., embodiments in the present disclosure are not limited in this respect. In an embodiment in the present disclosure, the server 130 and the electronic device 110 may implement signaling interaction through a communication connection between the server 130 and the electronic device 110.

It should be understood that the structures and functions of the various elements in the environment 100 are described for exemplary purposes only and do not imply any limitation to the scope of the present disclosure.

### Example Processes

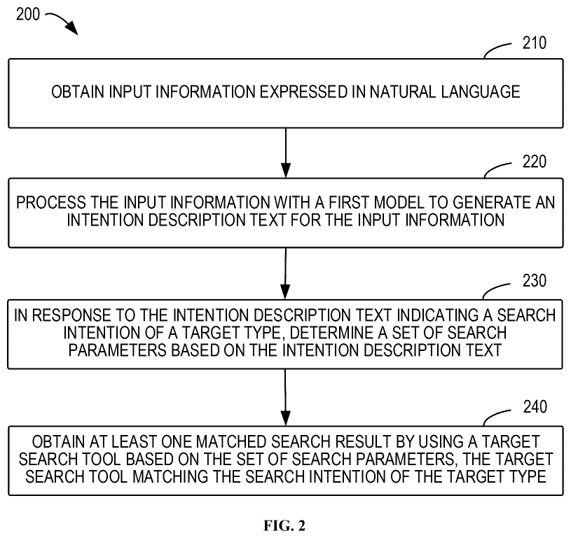

FIG. 2 illustrates a flowchart of an example information search process 200 according to some embodiments in the present disclosure. Process 200 may be implemented at electronic device 110, server 130, or other suitable electronic device. The process 200 is described below with reference to FIG. 1.

As shown, at block 210, the electronic device 110 obtains input information expressed in natural language.

In some embodiments, such input information of natural language expression may be in the form of text or speech, for example. It may be understood that such natural language may also be text or speech corresponding to multiple languages (for example, Chinese, English, Japanese). The present disclosure is not intended to limit the form or language of natural language.

In some embodiments, the electronic device 110 obtains input information expressed in natural language input by the target user. Such input information may be, for example, “Help me search for well-reviewed places serving boiled fish within 2 kilometers nearby, with convenient transportation”.

At block 220, the electronic device 110 processes the input information with a first model to generate an intention description text for the input information.

In some embodiments, such a first model may be, for example, a language model. The electronic device 110 may provide the input information and the guidance item to the first model to indicate the first model to identify the search intention corresponding to the input information (for example, “the user wants to find a place to eat the boiled fish”), so as to generate the intention description text for the input information.

In some embodiments, the electronic device 110 may also provide one or more available search tools, which may be, for example, point of interest search tools, navigation tools, and the like. In some embodiments, such a search tool may be, for example, an interface call based search tool, a search tool provided by an application, or the like.

Further, the electronic device 110 may determine a target search tool in available search tools based on the search intention. As an example, the electronic device 110 performs intention recognition on the input information based on the first model, to obtain “need to invoke the POI search tool”.

In this way, the electronic device 110 may obtain the intention description text generated by the first model for the input information. In some embodiments, such intention description text may be composed of three parts: the first part is the target user search intention corresponding to the input information, the second part is the available search tool of the current electronic device 110, and the third part is the target search tool determined by the electronic device 110 to execute the search intention. As an example, “a user wants to find a place to eat boiled fish, the currently available tools include a point of interest tool, a navigation tool, etc., and the POI search tool needs to be invoked this time.”

At block 230, the electronic device 110 determines a set of search parameters based on the intention description text in response to the intention description text indicating a search intention of the target type.

In some embodiments, such a target type of search intention may be, for example, a point of interest search intention, a navigation search intention, or the like.

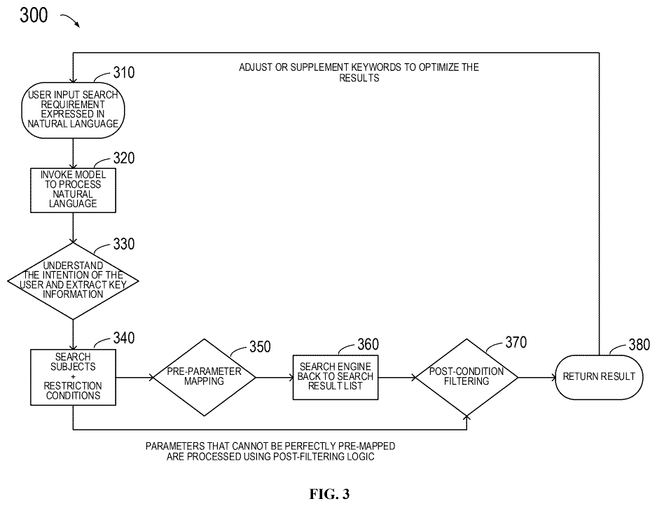

The processing process of the input information will be described in detail below with reference to FIG. 3.

With reference to the process described above, at block 310, the user may enter input information expressed in natural language. At block 320, the electronic device 110 invokes the first model to process the input information. At block 330, the electronic device 110 may generate the intention description text for the input information based on the first model.

In some embodiments, the electronic device 110 may provide intention description text to a second model to determine a set of search parameters 340. The set of search parameters 340 may include, for example, search keywords (e.g., search subjects) and search condition information (e.g., restriction conditions).

In some embodiments, the second model may be, for example, the same as the first model, and both are language models. Alternatively, the second model may be another model different from the first model.

In some embodiments, such search condition information may include, for example, screening conditions, sorting conditions, and filtering conditions.

As an example, the electronic device 110 may provide the second model with the above obtained intention description text “a user wants to find a place to eat boiled fish, the currently available tools include a point of interest tool, a navigation tool, etc., and the POI search tool needs to be invoked this time” to determine the search keyword and the search condition information.

Further, the electronic device 110 may analyze the intention description text based on the intention description text, the inference capability of the second model, and the additionally supplemented knowledge base information, to obtain that the “boiled fish” belongs to “Sichuan dish”, and the “well-reviewed” may be pushed out of “good evaluation priority”. Further, the electronic device 110 may further map the search keyword and the search condition information obtained by analysis, use the “Sichuan dish” as the search keyword, “0-2 km” as the screening condition, “prioritize positive reviews” as the sorting condition, and “Traffic convenience” as the filtering condition. It can be understood that the present disclosure is not intended to limit the number of keywords and search condition information.

Further, such a set of search parameters 340 may also be determined based on reference description information associated with the target user. For example, the electronic device 110 may determine such a set of search parameters based on historical search information of the target user.

In this way, the electronic device 110 may infer a potential search requirement of the user when the user intention is relatively fuzzy or uncertain, and generate a search keyword that is more consistent with the user's real demand, thereby improving the user's search experience.

At block 240, the electronic device 110 obtains at least one matched search result by using a target search tool based on the set of search parameters 340, the target search tool matching the search intention of the target type.

In some embodiments, the electronic device 110 may provide the search keywords and the predefined parameters 350 to a target search tool (e.g., a point of interest search tool). Such predefined parameters 350 may be, for example, screening conditions and sequencing conditions.

In this way, the electronic device 110 obtains the search result list 360 provided by the target search tool (e.g., the point of interest search tool) based on the search keyword and the predefined parameters 350. Further, the electronic device 110 may further utilize post-filtering logic. The electronic device 110 may further determine a matching search result 380 from the search results list 360 based on the filtering condition 370. Such a search result 380 may be, for example, the top few entries as the final search result 380 selected in the search list meeting the filtering condition.

In some embodiments, the input information mentioned above may be marked as the first input information. In response to obtaining the second input information, the electronic device 110 determines to update a set of search parameters based on the second input information, for example, the electronic device 110 may adjust the set of search parameters or supplement a search keyword for the set of search parameters to obtain an updated set of search parameters. Further, the electronic device 110 may update the search result based on the updated set of search parameters.

As an example, the electronic device 110 updates the screening condition 0-2 kilometer in the aforementioned set of search parameters to be 0 -500 meters in response to the target user continuing to ask (e.g., Is there anything within 500 meters?) . In turn, the electronic device 110 determines to update the search results based on the updated set of search parameters.

In this way, the embodiments in the present disclosure may convert the natural language intention of the user into a parameter that may be understood by the search engine, so that the search result better meets the user's real intention and needs. In addition, the electronic device continuously optimizes the search result by dynamically adjusting the search parameter, thereby improving user satisfaction and search efficiency.

### Example Apparatus and Apparatus

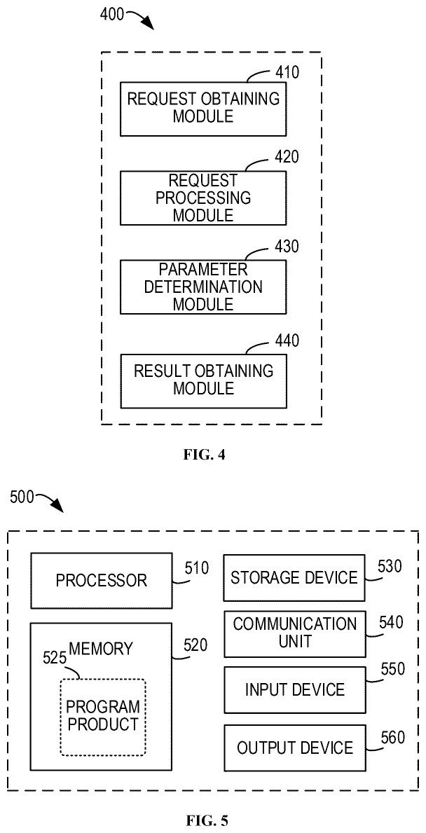

Embodiments in the present disclosure also provide a corresponding apparatus for implementing the above method or process. FIG. 4 shows a schematic structural block diagram of an example information searching apparatus 400 according to some embodiments in the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes a request obtaining module 410 configured to obtain input information expressed in natural language; a request processing module 420 configured to process the input information with a first model to generate an intention description text for the input information; a parameter determination module 430 configured to determine a set of search parameters based on the intention description text in response to the intention description text indicating a search intention of a target type; and a result obtaining module 440 configured to obtain at least one matched search result by using a target search tool based on the set of search parameters, the target search tool matching the search intention of the target type.

In some embodiments, the request processing module 420 is further configured to provide the input information and a guidance item to the first model, the guidance item being used to indicate the first model to recognize a search intention corresponding to the input information; and obtain the intention description text generated by the first model.

In some embodiments, the parameter determination module 430 is further configured to provide the intention description text to a second model to determine the set of search parameters, where the set of search parameters comprises at least one of the following: a search keyword or search condition information.

In some embodiments, the input information is from a target user, and the set of search parameters is further determined based on reference description information associated with the target user.

In some embodiments, the search condition information includes at least one of: at least one screening condition, at least one sorting condition, or at least one filtering condition.

In some embodiments, the result obtaining module 440 is further configured to provide the search keyword and a predetermined parameter to the target search tool, the predetermined parameter indicating the at least one screening condition and/or the at least one sorting condition; obtain a search result list provided by the target search tool; and determine the at least one matched search result from the search result list based on the at least one filtering condition.

In some embodiments, the search intention of the target type includes a point of interest search intention, and the target search tool comprises a point of interest search tool.

In some embodiments, the input information is first input information, and the apparatus 400 further includes a parameter updating module 410 configured to, in response to obtaining second input information, determine to update the set of search parameters based on the second input information; and provide an updated search result determined based on the updated set of search parameters.

The modules included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 400 may be implemented, at least in part, by one or more hardware logic components. By way of example and not limitation, exemplary types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 5 illustrates a block diagram of an electronic device 500 in which one or more embodiments in the present disclosure may be implemented. It should be understood that the electronic device 500 illustrated in FIG. 5 is merely exemplary and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments in the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for information searching, comprising:
obtaining input information expressed in natural language;
processing the input information with a first model to generate an intention description text for the input information;
in response to the intention description text indicating a search intention of a target type, determining a set of search parameters based on the intention description text; and
obtaining at least one matched search result by using a target search tool based on the set of search parameters, the target search tool matching the search intention of the target type.

2. The method of claim 1, wherein processing the input information with the first model to generate an intention description text for the input information comprises:
providing the input information and a guidance item to the first model, the guidance item being used to indicate the first model to recognize a search intention corresponding to the input information; and
obtaining the intention description text generated by the first model.

3. The method of claim 1, wherein determining the set of search parameters based on the intention description text comprises:
providing the intention description text to a second model to determine the set of search parameters, wherein the set of search parameters comprises at least one of the following: a search keyword or search condition information.

4. The method of claim 3, wherein the input information is from a target user, and the set of search parameters is further determined based on reference description information associated with the target user.

5. The method of claim 3, wherein the search condition information at least comprises at least one of:
at least one screening condition,
at least one sorting condition, or
at least one filtering condition.

6. The method of claim 5, wherein obtaining the at least one matched search result by using the target search tool based on the set of search parameters comprises:
providing the search keyword and a predetermined parameter to the target search tool, the predetermined parameter indicating the at least one screening condition and/or the at least one sorting condition;
obtaining a search result list provided by the target search tool; and
determining the at least one matched search result from the search result list based on the at least one filtering condition.

7. The method of claim 1, wherein the search intention of the target type comprises a point of interest search intention, and the target search tool comprises a point of interest search tool.

8. The method of claim 1, wherein the input information is first input information, and the method further comprises:
in response to obtaining second input information, determining to update the set of search parameters based on the second input information; and
providing an updated search result determined based on the updated set of search parameters.

9-12. (canceled)

13. An electronic device, comprising:
at least one processor; and
at least one memory coupled to the at least one processor and storing an instruction for execution by the at least one processor, the instruction, when executed by the at least one processor, causing the electronic device to perform acts comprising:
obtaining input information expressed in natural language;
processing the input information with a first model to generate an intention description text for the input information;
in response to the intention description text indicating a search intention of a target type, determining a set of search parameters based on the intention description text; and
obtaining at least one matched search result by using a target search tool based on the set of search parameters, the target search tool matching the search intention of the target type.

14. The device of claim 13, wherein processing the input information with the first model to generate an intention description text for the input information comprises:
providing the input information and a guidance item to the first model, the guidance item being used to indicate the first model to recognize a search intention corresponding to the input information; and obtaining the intention description text generated by the first model.

15. The device of claim 13, wherein determining the set of search parameters based on the intention description text comprises:
providing the intention description text to a second model to determine the set of search parameters, wherein the set of search parameters comprises at least one of the following: a search keyword or search condition information.

16. The device of claim 15, wherein the input information is from a target user, and the set of search parameters is further determined based on reference description information associated with the target user.

17. The device of claim 15, wherein the search condition information at least comprises at least one of:
at least one screening condition,
at least one sorting condition, or
at least one filtering condition.

18. The device of claim 17, wherein obtaining the at least one matched search result by using the target search tool based on the set of search parameters comprises:
providing the search keyword and a predetermined parameter to the target search tool, the predetermined parameter indicating the at least one screening condition and/or the at least one sorting condition;
obtaining a search result list provided by the target search tool; and
determining the at least one matched search result from the search result list based on the at least one filtering condition.

19. The device of claim 13, wherein the search intention of the target type comprises a point of interest search intention, and the target search tool comprises a point of interest search tool.

20. The device of claim 13, wherein the input information is first input information, and the acts further comprise:
in response to obtaining second input information, determining to update the set of search parameters based on the second input information; and
providing an updated search result determined based on the updated set of search parameters.

21. A non-transitory computer-readable storage medium with a computer program stored thereon, the computer program being executable by a processor to implement acts comprising:
obtaining input information expressed in natural language;
processing the input information with a first model to generate an intention description text for the input information;
in response to the intention description text indicating a search intention of a target type, determining a set of search parameters based on the intention description text; and
obtaining at least one matched search result by using a target search tool based on the set of search parameters, the target search tool matching the search intention of the target type.

22. The non-transitory computer-readable storage medium of claim 21, wherein processing the input information with the first model to generate an intention description text for the input information comprises:
providing the input information and a guidance item to the first model, the guidance item being used to indicate the first model to recognize a search intention corresponding to the input information; and
obtaining the intention description text generated by the first model.

23. The non-transitory computer-readable storage medium of claim 21, wherein determining the set of search parameters based on the intention description text comprises:
providing the intention description text to a second model to determine the set of search parameters, wherein the set of search parameters comprises at least one of the following: a search keyword or search condition information.

24. The non-transitory computer-readable storage medium of claim 23, wherein the input information is from a target user, and the set of search parameters is further determined based on reference description information associated with the target user.
